(19) United States
(12) Patent Application Publication
(10) Pub. No.: US 2006/0174446 A1
(43) Pub. Date: Aug. 10, 2006

(54) Knob for furniture

(76) Inventors: Horst Lautenschlager, Reinheim (DE); Earl David Forest, Asheboro, NC (US); Christopher D. Wolfe, High Point, NC (US)

Correspondence Address: Edgar A. Zarins;Masco Corporation, 21001 Van Born Road, Taylor, MI, 48180, US

(21) Appl. No.: 11/339,100

(22) Filed: Jan. 25, 2006

(30) Foreign Application Priority Data
Jan. 25, 2005 (DE) 10 2005 003 538.8

(51) Int. Cl. E05B 1/00

(52) U.S. Cl. 16/417

(57) ABSTRACT

A knob (1) for furniture includes a knob top (4), on the under side of which a separate knob base (5) is connected. The knob top (4) and the knob base (5) are concentric and enclose an interior hollow space (6). A threaded bore (9) is formed in a central shaft (8) extending from the inner wall (7) of the knob top (4). A fastener (2) extends through a central hole (16) of the knob base (5) and is screwed into the threaded hole (9). The central protrusion (8) may be extended to be received with in the opening of the base (5).

### BACKGROUND OF THE INVENTION

I. Field of the Invention

This invention relates to a knob for furniture having a knob head and a knob base extending from the knob head and, in particular, to a hollow knob construction with interchangeable head configurations having an open threaded bore to accommodate a fastener to secure the knob assembly.

II. Description of the Prior Art

Knobs of this sort have long been known in various designs. They are particularly used on furniture for drawers and furniture doors and serve to move the furniture parts to which they are attached. Frequently the knob base is designed narrower than the upper part of the knob as described here. This facilitates the user exerting tension on the knob because the user can grip the knob, which is broader than the base.

Known knobs of this type are made out of one piece of solid material. This results in a relatively high requirement for materials. For aesthetic reasons many different designs of knobs are desired. For each of these designs a special manufacturing mold, for example an injection die, must be prepared for the entire knob. The expense required for this is considerable.

### SUMMARY OF THE PRESENT INVENTION

The present invention overcomes the disadvantages of the prior art by providing knob of the type that can be produced with a small requirement for material and in which various configurations and designs can be manufactured at a reduced cost of manufacture.

These goals are achieved by the invention in that the knob and the base are separate components, having a common axis and surrounding an inner hollow space, in that the threaded hole is formed in an axial shaft on the inner wall of the knob and that the knob base includes an axial bore through which the fastener extends. The two-part design of the knob makes it possible to combine knob bases readily produced in large numbers with various knob tops. These various knob tops are significantly smaller than the entire knob and thus can be produced at smaller expense than one-piece knobs.

By joining the knob top with the knob base, a relatively larger hollow knob can be produced so that the material requirements for the knob are significantly reduced in comparison to a one-piece solid design. Because the fastener is secured into the knob top, a connection is thus established between the knob top and the knob base without any extra connection means. Despite the relatively long length of the fastener, good centering of the knob top is accomplished in assembly because the securing fastener is already centered in the knob base. Therefore even relatively long, slender fasteners can be used.

The knob base can be made as a thin-walled, rotationally symmetrical hollow piece without affecting the function or the appearance of the knob top provided that the transverse wall has a central hole for the fastener. Such a thin-wall component can be manufactured with low material and manufacturing costs.

A preferred embodiment of the invention provides that the knob base includes an upper centering edge, which is centered upon a centering surface of the knob top. This prevents in a simple way a relative displacement of the knob top and the knob base ensuring proper alignment. The axial shaft extending from the knob top may be long enough to mate with the central bore of the knob base.

Other objects, features and advantages of the invention will be apparent from the following detailed description taken in connection with the accompanying drawing.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is longitudinal sectional view of a preferred embodiment of a knob attached to a furniture piece;

FIG. 2 is an exploded view of the knob;

FIG. 3 is an end view in the direction of arrow III in FIG. 2;

FIGS. 4 and 5 illustrate modified embodiments of the knob base;

FIGS. 6 thru 9 illustrate modified embodiments of the knob top in section;

FIGS. 10 and 11 depict a still further embodiment of the multiple piece knob construction of the present invention; and

FIGS. 12 through 14 illustrate still further embodiments of the knob base.

### DETAILED DESCRIPTION OF A PREFERRED EMBODIMENT OF THE PRESENT INVENTION

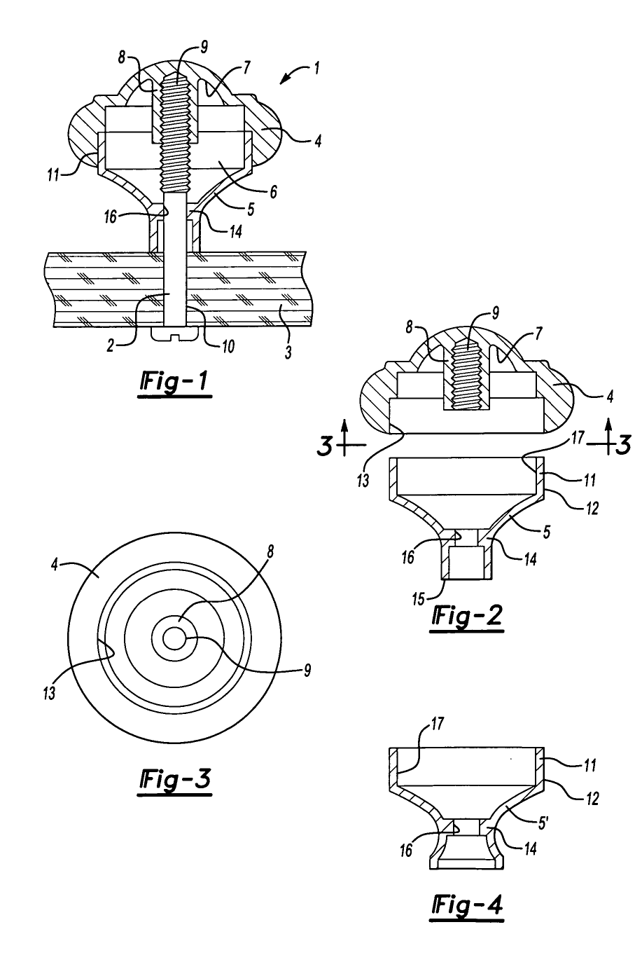

Referring first to FIGS. 1-3, there is shown a knob 1 attached by means of a fastener 2 on a furniture part 3, for example, a front face of a furniture drawer. Knob 1 is made in two pieces including a knob top 4 on the underside of which protrudes a knob base 5. The knob top 4 and the knob base 5 are concentrically attached to enclose a hollow knob interior space 6.

A threaded bore 9, made as a blind hole, is located in an essentially cylindrical protrusion or shaft 8 extending downward from an upper inner wall 7 of knob top 4. Fastener 2 extends from the interior of the drawer through hole 10 and is secured into threaded bore 9. The thin-walled, symmetrical, chalice-shaped knob base 5 includes an upper centering edge 11, the cylindrical centering surface 12 of which is accommodated by a cylindrical centering surface 13 of knob top 4. A transverse wall 14 in knob base 5, located a short distance above the lower exterior face 15 of knob base 5, includes an axial centering hole 16 through which the fastener 2 extends and is thereby centered when the knob is assembled (FIG. 1).

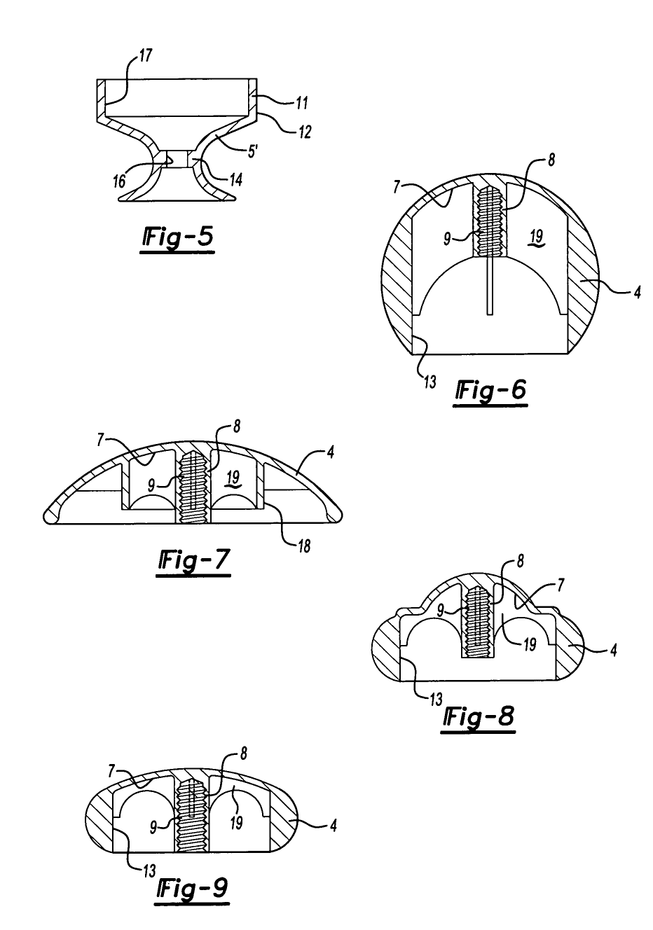

The modified embodiments of the centering base 5 shown in FIGS. 4 and 5 differ only in their outer contour. Both knob bases 5 are constricted in the vicinity of transverse wall 14 and expand downward to their lower end. All of these knob bases 5 include an upper centering edge 11 with the centering exterior surface 12, which surface is centered on a corresponding cylindrical centering inner surface 13 of each of the knob tops 4. In FIGS. 6, 8 and 9 it is indicated that the knob tops may exhibit very different exterior contours with each having such an internal centering surface 13.

The upper centering edge 11 on knob base 5 in all of the embodiments depicted also includes a cylindrical inner centering surface 17 that can accommodate an external cylindrical centering surface 18 of the knob top 4 as shown in FIG. 7. Thus, each of the knob tops 4 shown in FIGS. 1-3 and 6-9, varying in their exterior shapes, can be freely combined with all of the knob bases 5 shown in FIGS. 1, 2 and 4, 5.

The knob tops 4 shown in FIGS. 6-9 exhibit radial ribs 19, by means of which an interior stiffening of knob top 5 is achieved so that it can be made relatively thin-walled.

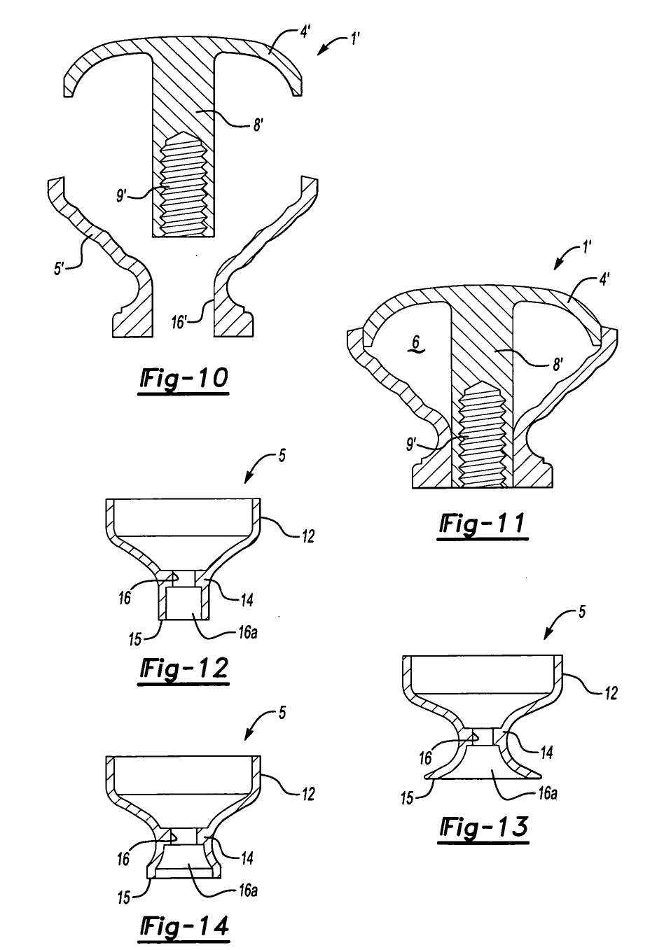

FIGS. 10 and 11 illustrate a further embodiment of the multi-piece knob construction. In this embodiment, the cylindrical shaft 8′ formed on the underside of the knob top 4′ is extended such that upon joining of the top 4′ and base 5′, the shaft 8′ is matingly received with in the cylindrical opening 16′ of the base 5′. The threaded bore 9′ adapted to receive the fastener 2 is disposed at the end of the knob 1 for ease of insertion of the fastener 2 to secure the knob construction.

Further modifications to the knob base 5 are shown in FIGS. 12 through 14. The cavity 16a has a domed configuration to facilitate insertion of the fastener 2 through the opening 16. By utilizing a curved end wall, the fastener 2 is guided to the opening 16.

The foregoing detailed description has been given for clearness of understanding only and no unnecessary limitations should be understood therefrom as some modifications will be apparent without departing from the scope and spirit of the appended claims.

What is claimed:

1. A knob for furniture having a knob top, a knob base connected to the knob top, the knob top including a threaded bore on its underside to accommodate a fastener, the improvement comprising the knob top (4) and the knob base (5) are separate concentric components enclosing an interior space (6), that the threaded bore (9) is formed in a central protrusion (8) of the inner wall (7) of the knob top and that the knob base (5) includes a central passageway (16) through which the fastener (2) extends.

2. The knob in accordance with claim 1, characterized in that the knob base (5) includes an upper centering edge, centered on a centering surface (13) of the knob top (4).

3. The knob in accordance with claim 1, characterized in that the upper centering edge (11) of the knob base (5) includes a cylindrical exterior centering surface (12) which is surrounded by the cylindrical centering surface (13) of knob top (4).

4. The knob in accordance with claim 2, characterized in that the upper centering edge (11) of knob base (5) includes a cylindrical inner centering surface (17) which is accommodated by a cylindrical outer centering surface (18) of knob top (4).

5. The knob in accordance with claim 4, characterized in that the knob base (5) is made as a thin-walled, rotationally symmetrical hollow part and that a transverse wall (14) contains the central opening (16) for the fastener (2).

6. The knob in accordance with claim 5, characterized in that the central protrusion (8) of the knob top (4) extends into the central opening (16) of the knob base (5).

7. The knob as defined in claim 5 wherein said axial passageway in said knob base includes a domed wall to guide said fastener through said passageway.

8. A knob adapted to be mounted to a furniture piece using a fastener, the knob including a knob top and a knob base interconnected by the fastener, said knob comprising:
an axial shaft extending from an underside of said knob top, said shaft including a bore;
an axial passageway formed in said knob base, said fastener extending through said passageway of said knob base to threadably engage said bore to interconnect said knob base and knob top.

9. The knob as defined in claim 8 wherein said knob top and said knob base include outer concentric rims such that said outer rims are matingly engaged upon interconnection of said knob base and knob top forming an interior hollow space within said knob.

10. The knob as defined in claim 9 wherein said axial shaft extends into said axial passageway of said knob base such that said threaded bore is disposed at a base end of said knob.

11. The knob as defined in claim 8 wherein said bore is threaded to threadably receive said fastener.

12. The knob as defined in claim 8 wherein said axial passageway in said knob base includes a domed wall to guide said fastener through said passageway.
